(19) United States
(12) Patent Application Publication
(10) Pub. No.: US 2007/0215223 A1
(43) Pub. Date: Sep. 20, 2007

(54) Selector valve

(75) Inventor: John Michael Morris, Auburn, WA (US)

Correspondence Address: THE OLLILA LAW GROUP LLC, 2060 BROADWAY, SUITE 300, BOULDER, CO, 80302, US

(73) Assignee: GT Development Corporation, Seattle, WA (US)

(21) Appl. No.: 10/966,953

(22) Filed: Oct. 15, 2004

(51) Int. Cl. B60G 17/052

(52) U.S. Cl. 137/627.5

(57) ABSTRACT

A modular selector valve (100) for selectively directing a flow of a fluid. The modular selector valve includes one or more three-way valves (110, 112, or 113)removably coupled to one another. The modular selector valve also includes an actuator assembly (126) actuatable to simultaneously actuate each of the one or more three-way valves between a first position and a second position. In the first position, a fluid is directed along a first path through each of the one or more three-way valves. In the second position, the fluid is directed along a second path through each of the one or more three-way valves.

### FIELD OF THE INVENTION

The present invention relates generally to valves and more specifically to valves adapted to selectively direct flow between one or more flow paths.

### BACKGROUND OF THE INVENTION

Many vehicles utilize both a primary fuel tank and a secondary fuel tank, thereby necessitating a selector valve permitting a user to select which fuel tank should be providing fuel to the engine and which tank should be receiving a return flow from the engine at a given time. One such previously developed fuel selector valve is disclosed in U.S. Pat. No. 4,683,864 issued to Bucci (hereinafter “Bucci”).

Although useable, the selector valve of Bucci is not without its problems. For example, referring to FIG. 10 of Bucci, the selector valve of Bucci requires many parts to assemble which increases the manufacturing cost, complexity, failure rate, and retail cost of the selector valve. For instance, instead of using a single sealing member, each diverter valve of Bucci requires a pair of opposing O-rings 74 and 76 biased away from each other by a spring 82. Thus, each diverter valve requires a pair of O-rings 74 and 76 and a biasing spring 82 to selectively seal against a pair of opposing sealing surfaces 78 and 80 of the selector valve, thereby increasing the complexity of the selector valve.

Further, Bucci requires multiple parts to form the pair of opposing sealing surfaces 78 and 80 upon which the O-rings 74 and 76 sealingly engage. Moreover, to form the pair of opposing sealing surfaces in the selector valve of Bucci, a first sealing surface 78 is integrally formed in the selector valve. To form the opposing sealing surface, a fixed housing 64 is inserted in a valve body 38 to provide a second sealing surface 80 disposed opposite the first sealing surface 78. To seal the fixed housing 64 to the valve body 38, 0-rings 68 and 70 are used, further increasing the complexity of the selector valve. Thus, to form the first and second sealing surfaces 78 and 80, a fixed housing 64 along with a pair of 0-rings 68 and 70 must be inserted into the valve body, increasing the complexity of the selector valve. Therefore, there exists a need for a selector valve having a diverter valve requiring fewer parts to reduce the complexity, failure rate, and/or cost of the valve.

Second, the selector valve of Bucci is not adjustable to adapt to different environments having different plumping configuration needs. For instance, referring to FIG. 1 of Bucci, the selector valve of Bucci includes a plurality of inlet and outlet ports 46, 48, 50, 52, 54, and 56 which are positioned in a fixed configuration relative to one another. Inasmuch as the inlet and outlet ports 46-56 are disposed in a fixed relationship to one another, the orientation of the inlet and outlet ports of Bucci cannot be adjusted to accommodate different environments requiring different orientations of the ports, for instance to enhance ease of installation and placement of piping connected to the selector valve. Thus, there exists a need for a selector valve wherein the orientation of the inlet and outlet ports may be adjusted to accommodate different plumping needs.

Third, the selector valve of Bucci is not adaptable in its configuration to accommodate alternate flow needs. The selector valve is designed for a single environment wherein a pair of tanks are coupled in fluid communication to an engine, wherein the selector valve must direct both supply and return fuel flow paths from the vehicle's fuel system. Thus, the selector valve of Bucci is not adaptable to accommodate different environments, such as a vehicle fuel system which does not utilize a fuel recirculation system, such that the selector valve is no longer required to direct fuel returned from the vehicle's fuel system. Therefore, another selector valve must be designed and stocked to handle this situation. Thus, there exists a need for a selector valve which is adaptable to accommodate alternate flow needs.

### SUMMARY OF THE INVENTION

One embodiment formed in accordance with the present invention of a selector valve for selectively directing fluid flow between two or more flow paths is disclosed. The selector valve includes a valve housing having a first sealing surface and a second sealing surface substantially facing each other. The first and second sealing surfaces are integrally formed with the valve housing so as to be non-removably and homogeneously formed with the valve housing. The selector valve also includes a cavity disposed in the valve housing between the first and second sealing surfaces and a first port in fluid communication with the cavity and the first sealing surface. The selector valve further includes a second port in fluid communication with the cavity and the second sealing surface and a third port in fluid communication with the cavity. A sealing member is linearly moveable within the cavity to selectively seal against the first or second sealing surface to selectively impede flow through the first and second ports.

Another embodiment formed in accordance with the present invention of a modular selector valve assembly for selectively directing flow between two or more flow paths is disclosed. The modular selector valve assembly includes a first selector valve body having a first cavity disposed in the first selector valve body, a first port in fluid communication with the first cavity, a second port in fluid communication with the first cavity, and a third port in fluid communication with the first cavity. The modular selector valve assembly also includes a second selector valve body removably coupled to the first selector valve body, the second selector valve body having a second cavity disposed in the second selector valve body, a fourth port in fluid communication with the second cavity, a fifth port in fluid communication with the second cavity, and a sixth port in fluid communication with the second cavity. The modular selector valve assembly additionally includes an actuator having a first sealing member and a second sealing member coupled thereto. The actuator is moveable to position the first and second sealing members to impede flow through either the first and fourth ports or the second and fifth ports.

An additional embodiment formed in accordance with the present invention of a modular selector valve assembly for selectively directing flow between two or more flow paths is disclosed. The modular selector valve includes a first modular selector valve body selectively couplable to a second modular selector valve body substantially identical to the first modular selector valve body. The first modular selector valve body may be coupled to the second modular selector valve body to selectively expand the modular selector valve assembly such that the second modular selector valve body, when attached to the first modular selector valve body, is adapted to be simultaneously actuated by an actuator common to both the first and second modular valve bodies. The first modular valve body includes a first cavity disposed in the first selector valve body, a first port in fluid communication with the first cavity, a second port in fluid communication with the first cavity, and a third port in fluid communication with the first cavity. The modular selector valve assembly includes an actuator having a first sealing member coupled thereto, wherein the actuator is moveable to a first position and a second position. In the first position, the first sealing member is positioned in the first cavity to direct a fluid flow between the third and first ports and not the second port. In the second position, the first sealing member is positioned in the first cavity to direct the fluid between the third and second ports and the not the first port.

Still another embodiment formed in accordance with the present invention of a selector valve for selectively directing fluid flow between two or more flow paths is disclosed. The selector valve includes a valve housing having a first sealing surface and a second sealing surface and a cavity disposed in the valve housing between the first and second sealing surfaces. The selector valve further includes a first port in fluid communication with the cavity and the first sealing surface, a second port in fluid communication with the cavity and the second sealing surface, and a third port in fluid communication with the cavity, the third port removably coupled to the valve housing. The selector valve additionally includes a sealing member moveable within the cavity to seal against the first and second sealing surfaces. The sealing member is sized and shaped to be inserted into the cavity when the third port is removed from the valve housing.

Still yet another embodiment formed in accordance with the present invention of a selector valve for selectively directing a flow of a fluid is disclosed. The selector valve includes a first three-way valve, a second three-way valve coupled to the first three-way valve, and an actuator assembly for simultaneously actuating the first and second three-way valves to selectively change a flow of a fluid through the first and second three-way valves. The first three-way valve is rotatingly coupled to the second three-way valve such that an orientation of the first three-way valve may be adjusted relative to the second three-way valve.

Yet another additional embodiment formed in accordance with the present invention of a modular selector valve for selectively directing a flow of a fluid is disclosed. The modular selector valve includes two or more three-way valves removably coupled to one another and an actuator assembly actuatable to simultaneously actuate each of the two or more three-way valves between a first position and a second position. In the first position, a fluid is directed along a first path through each of the two or more three-way valves. In the second position, a fluid is directed along a second path through each of the two or more three-way valves.

### BRIEF DESCRIPTION OF THE DRAWINGS

The foregoing aspects and many of the attendant advantages of this invention will become better understood by reference to the following detailed description, when taken in conjunction with the accompanying drawings, wherein:

FIG. 1 is a perspective view of one embodiment of a selector valve formed in accordance with the present invention, the selector valve shown in an assembled form;

FIG. 2 is an exploded perspective view of the selector valve of FIG. 1, with an actuator assembly not shown for clarity;

FIG. 3 is an elevation view of the selector valve of FIG. 1;

FIG. 4 is a cross-sectional view of the selector valve of FIG. 5 taken substantially through section 4-4 of FIG. 5;

FIG. 5 is a top view of the selector valve of FIG. 1;

FIG. 6 is a cross-sectional view of the selector valve of FIG. 3 taken substantially through section 6-6 of FIG. 3 with a pair of sealing members shown in a first position directing a fluid flow through the selector valve in a first manner;

FIG. 7 is a cross-sectional view of the selector valve of FIG. 3 taken substantially through section 6-6 of FIG. 3 with the pair of sealing members shown in a second position directing the fluid flow through the selector valve in a second manner;

FIG. 8 is a perspective view of the selector valve of FIG. 1, wherein the second modular valve body has been rotated 90 degrees relative to the first modular valve body to provide an alternate orientation of an array of ports of the selector valve;

FIG. 9 is a perspective view of an alternate configuration of the selector valve of FIG. 1, wherein the second modular valve body has been removed; and

FIG. 10 is a perspective view of an alternate configuration of the selector valve of FIG. 1, wherein a third modular valve body has been added.

### DETAILED DESCRIPTION OF THE PREFERRED EMBODIMENT

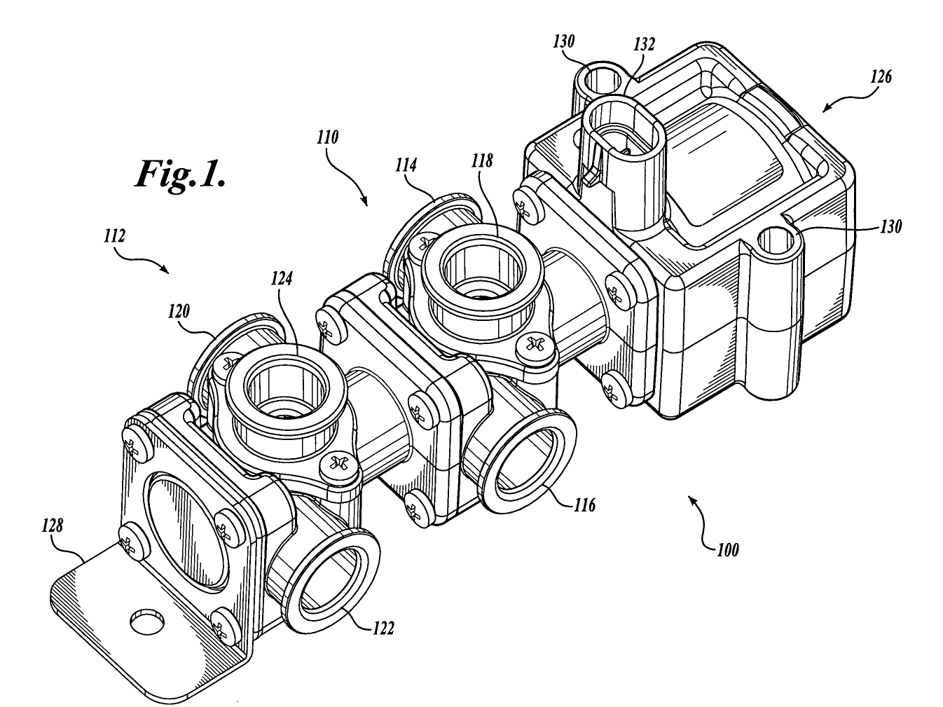

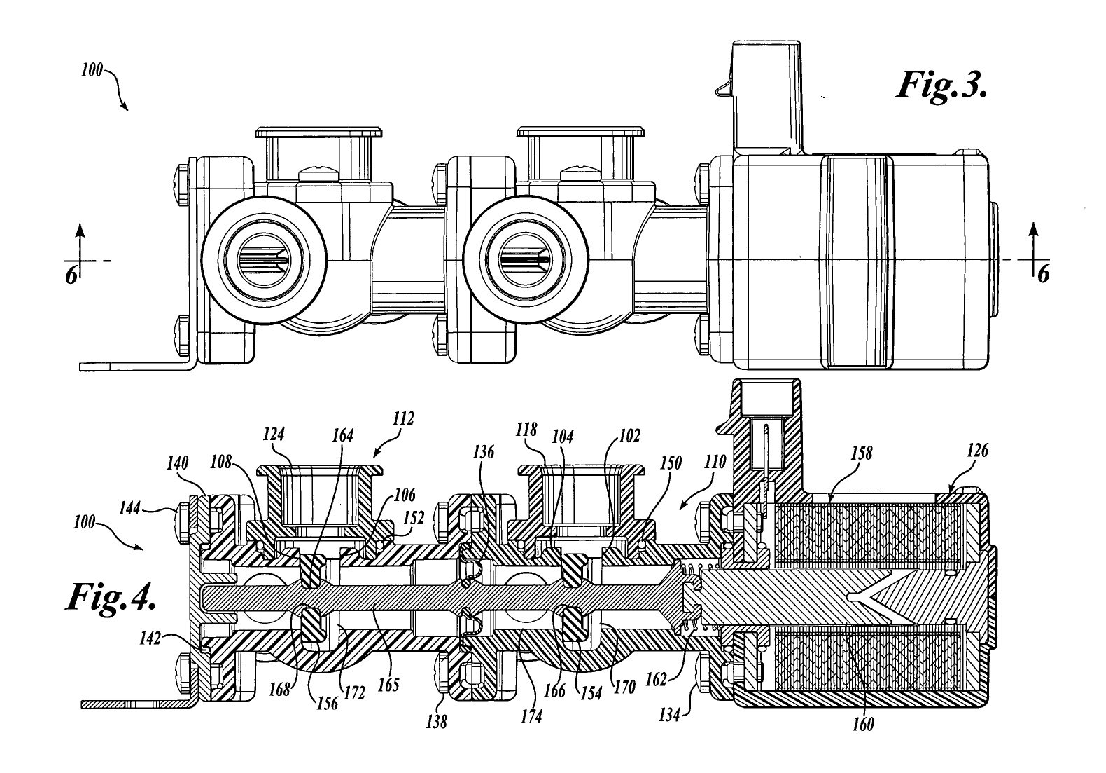

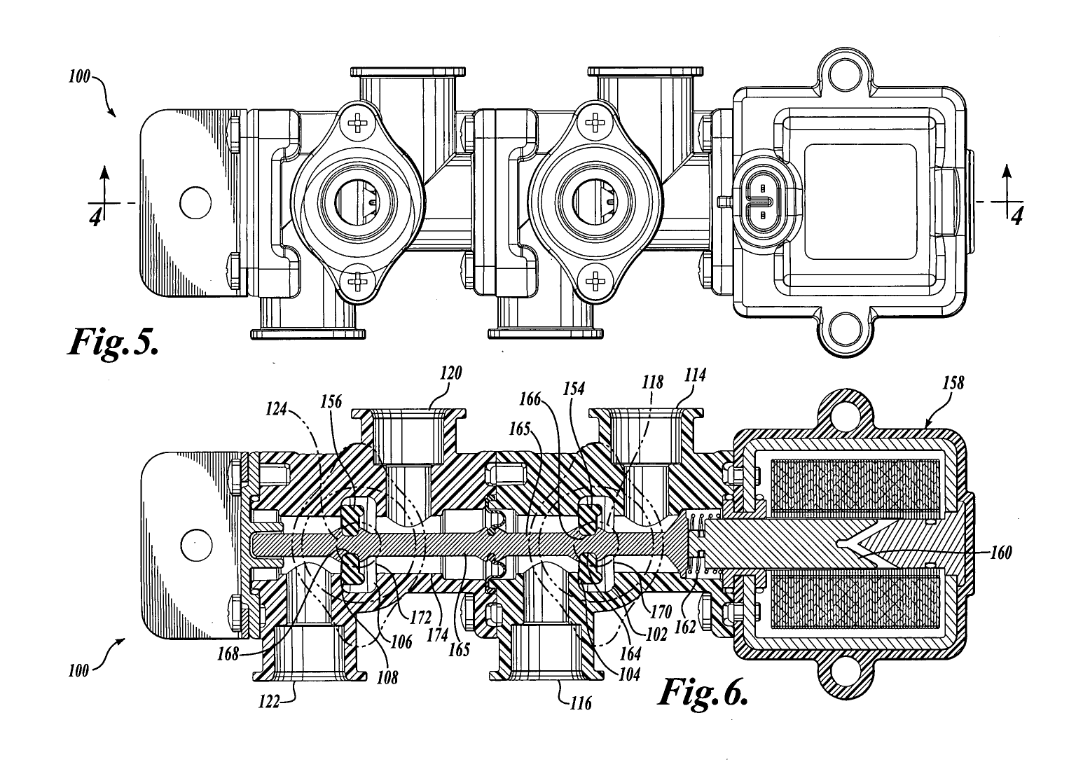

Referring to FIGS. 1-10, one embodiment of a selector valve 100 formed in accordance with the present invention is depicted. Generally described, the selector valve 100 is operable to selectively direct a flow of fuel to and from an engine of a vehicle (not shown) and a pair of fuel tanks (not shown). Referring to FIG. 4, the selector valve 100 includes a first pair of sealing surfaces 102 and 104 which are integrally formed with a first modular valve body 110 and a second pair of sealing surfaces 106 and 108 integrally formed with a second modular valve body 112. By integrally forming the sealing surfaces 102, 104, 106, and 108 with the first and second modular valve bodies 110 and 112, the complexity of the selector valve 100 is reduced.

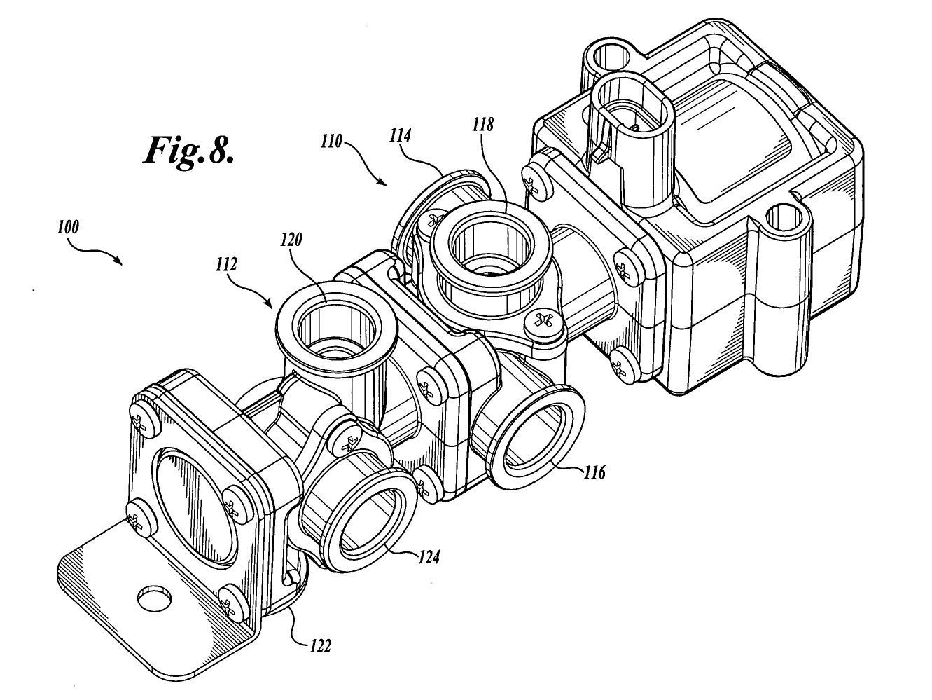

Further, the selector valve 100 is modular in design such that the second modular valve body 112 is removably coupled to the first modular valve body 110. The second modular valve body 112 may be rotated relative to the first modular valve body 110 such that an orientation of a first set of ports 114, 116, and 118 may be adjusted in orientation relative to a second set of ports 120, 122, and 124 (See FIG. 8). Likewise, a mounting plate 128 and an actuator assembly 126 may be mounted in a plurality of orientations relative to the first and second modular valve bodies 110 and 112 to further improve the versatility of the selector valve 100.

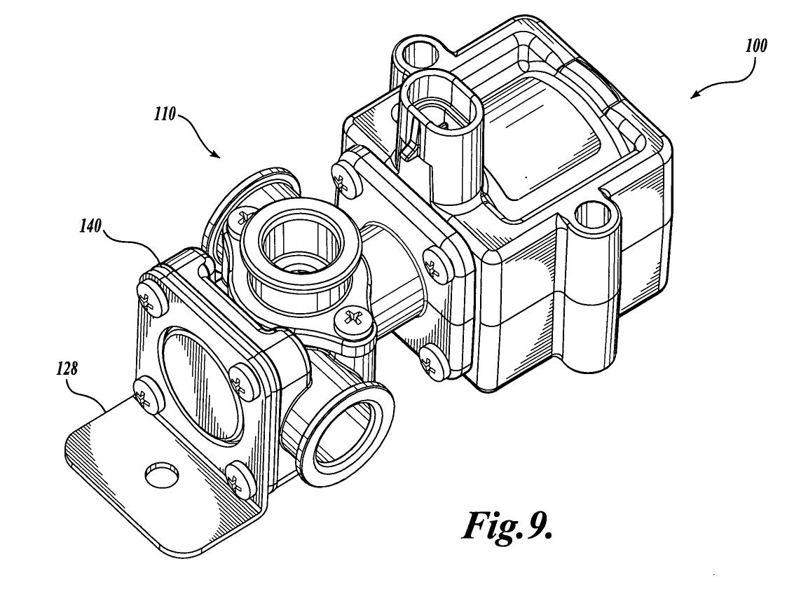

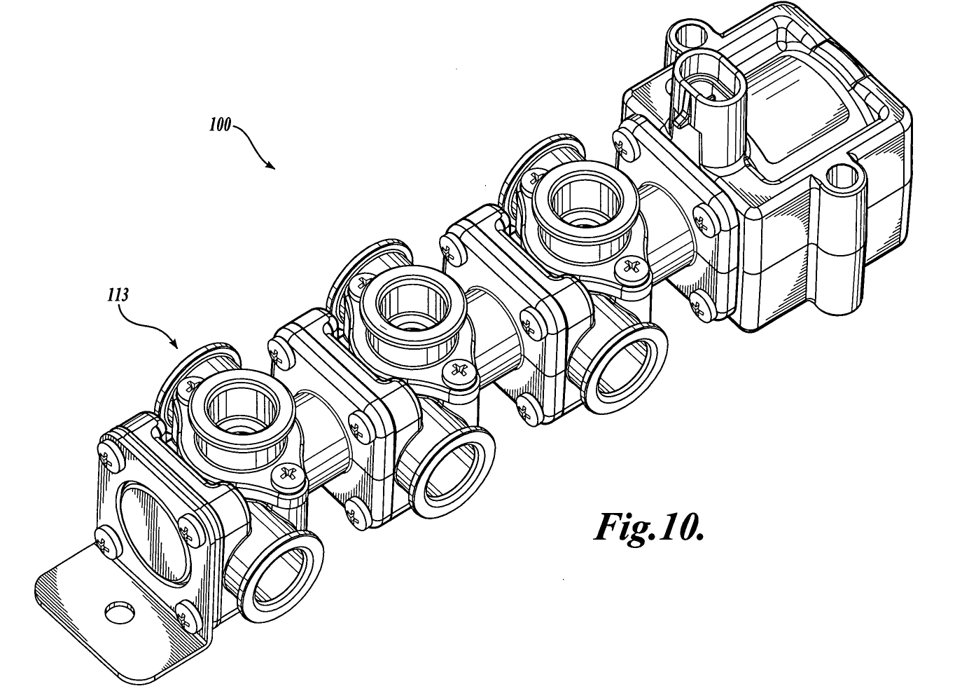

Second, the selector valve 100 is modular in design such that the second modular valve body may be removed (See FIG. 9) from the selector valve 100 and the selector valve 100 used in a situation wherein management of return flow by the selector valve 100 is not needed, or a third modular valve body 113 added to increase capacity (See FIG. 10). Thus, the selector valve 100 is able to adapt to many different environments requiring different orientation of inlet and outlet ports and different flow configurations.

Referring to FIG. 1, and focusing more specifically on the components of the selector valve 100, the selector valve 100 includes the first and second modular valve bodies 110 and 112 coupled to one another, each modular valve body forming a three-way valve. The first and second modular valve bodies 110 and 112 are in turn coupled to an actuator assembly 126 for selectively actuating the selector valve 100 to control the flow of fuel through the selector valve 100 as will be described in more detail below. The actuator assembly 126 includes a connector 132 permitting the electrical coupling of the actuator assembly 126 to the vehicle's power and control systems. The selector valve 100 further includes a mounting plate 128 and two mounting bores 130 for assisting the mounting of the selector valve 100 to a vehicle.

The first modular valve body 110 includes a first port 114 for drawing fuel from a primary fuel tank (not shown), a second port 116 for drawing fuel from a secondary fuel tank (not shown), and a third port 118 for directing fuel flow to a vehicle's engine (not shown). The second modular valve body 112 includes a fourth port 120 for returning fuel to the primary fuel tank, a fifth port 122 for returning fuel to the secondary fuel tank, and a sixth port 124 for receiving fuel from a vehicle's engine (not shown).

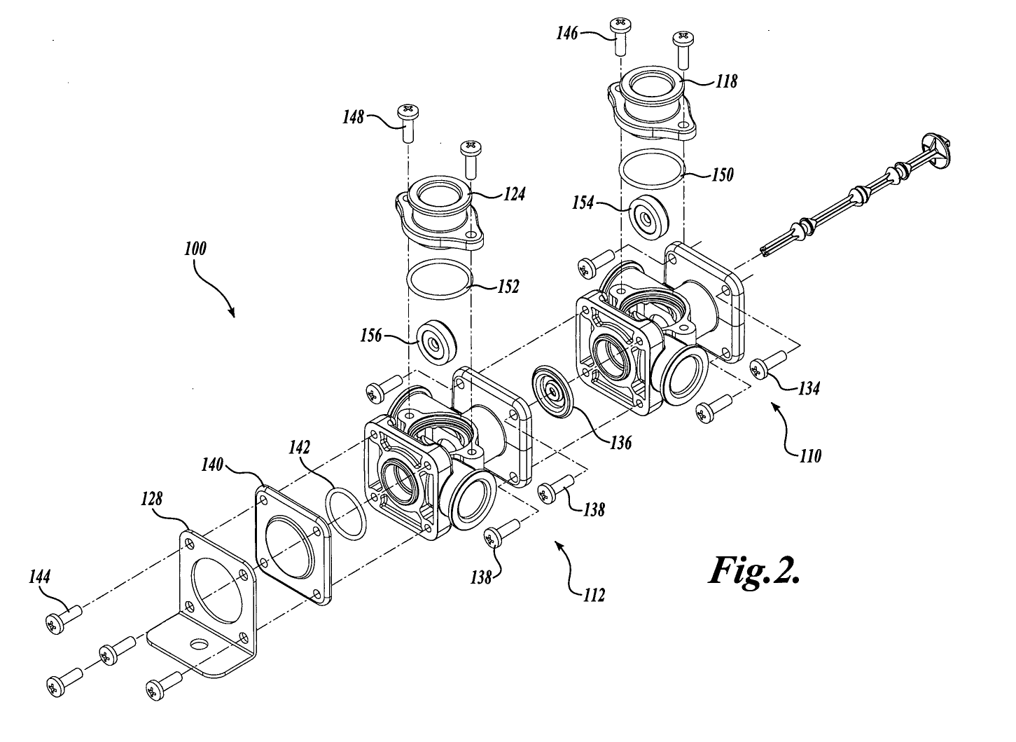

Referring to FIGS. 2 and 4, the selector valve 100 includes the first and second modular valve bodies 110 and 112, which are identical to one another. The first and second modular valve bodies 110 and 112 are coupled to one another by a plurality of fasteners 138. A diaphragm 136 seals the first and second modular valve bodies 110 and 112 to one another and impedes fluid flow between the two modular valve bodies 110 and 112. A second set of fasteners 134 is used to couple the first modular valve body 110 to the actuator assembly 126. An end plate 140, in combination with an 0-ring 142, is used to seal the outboard end of the second modular valve body 112. The end plate 140 is compressed against the second modular valve body 112 by sandwiching of the end plate 140 between the mounting plate 128 and the second modular valve body 112. The mounting plate 128 is coupled to the second modular valve body 112 by a set of fasteners 144.

The third and sixth ports 118 and 124 are removably coupled to the first and second modular valve bodies 110 and 112 respectively by a first and second pair of fasteners 146 and 148. The third and sixth ports 118 and 124 are sealed to the valve bodies 110 and 112 by O-rings 150 and 152. With the third and sixth ports 118 and 124 removed from the valve bodies 110 and 112, a pair of sealing members 154 and 156 may be inserted within the valve bodies 110 and 112 to facilitate assembly of the selector valve 100 as will be described in more detail below.

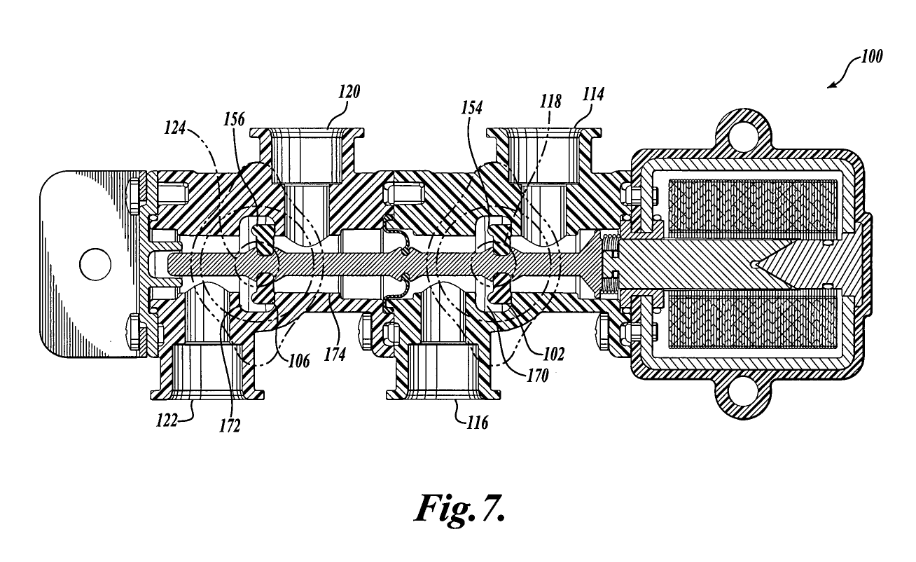

Referring to FIGS. 4 and 6, the internal components of the selector valve 100 will now be described in further detail. The actuator assembly 126 includes a solenoid 158 for linearly driving an armature 160 from an extended position shown in FIGS. 4 and 6 to a retracted position shown in FIG. 7. The armature 160 is normally biased in the extended position by a biasing member 162, such as a spring. The armature 160 is coupled to an actuator shaft 165. The first and second sealing members 154 and 156 are in turn coupled to the actuator shaft 165. More specifically, the first and second sealing members 154 and 156 each include an elastic aperture 164. During installation, with the third port 118 removed, the first sealing member 154 is inserted with the first modular valve body 110. The actuator shaft 165 is then linearly driven through the first modular valve body 110 and through the elastic aperture 164 of the first sealing member 154. The third port 118 is then replaced upon the first modular valve body 110. A diaphragm 136 is then pushed over the distal end of the actuator shaft 165. With the sixth port 124 removed, the second sealing member 156 is inserted within the second modular valve body 112. The actuator shaft 165 is then linearly driven through the second modular valve body 112 and through the elastic aperture 164 of the second sealing member 156. The sixth port 124 is replaced and the first and second modular valve bodies 110 and 112 coupled to one another in a selected angular orientation relative to one another. The mounting plate 128 and the actuator assembly 126 are coupled in a selected angular orientation relative to the first and second valve bodies 110 and 112.

The actuator shaft 165 includes a pair of reduced profile sections 166 and 168, forming channels or seats in the actuator shaft 165. The elastic apertures 164 expand as the actuator shaft 165 is slid through the elastic apertures 164 and contract as the elastic apertures 164 are positioned in the reduced profile sections 166 and 168, thereby retaining the sealing members 154 and 156 upon the actuator shaft 165. The diaphragm 136 is coupled to the actuator shaft 165 in a similar manner.

Still referring to FIGS. 4 and 6, the first modular valve body 110 includes a first slot or cavity 170 and the second modular valve body 112 includes a second slot or cavity 172. The actuator shaft 165 runs axially through both of the cavities 170 and 172 through a central passage 174. Disposed on opposing sides of the first cavity 170 is a first pair of sealing surfaces 102 and 104. Disposed on opposing sides of the second cavity 172 is a second pair of sealing surfaces 106 and 108. The sealing surfaces 102, 104, 106, and 108 are integrally formed with their respective modular valve body 110 or 112, such that the sealing surfaces are non-removably and homogeneously formed with their respective modular valve body 110 or 112 to form a unitary component. The sealing members 154 and 156 may be linearly driven by the actuator assembly 126 to sealingly engage the sealing surfaces 102, 104, 106, and 108. In fluid communication with the first cavity 170 is the first, second, and third ports 114, 116, and 118. In fluid communication with the second cavity 172 is the fourth, fifth, and sixth ports 120, 122, and 124.

In light of the above description of the components of the selector valve 100, the operation of the selector valve 100 will now be described. Referring to FIG. 6, in one preferred use of the selector valve 100, the selector valve 100 is used to direct the flow of fuel between an engine (not shown) of a vehicle and one of two fuel tanks (not shown). Generally described, when the selector valve 100 is configured in a first position, such as shown in FIG. 6, the selector valve 100 draws fuel from a primary fuel tank and directs the fuel to the engine. The selector valve 100 also directs any fuel returned from the engine back to the primary fuel tank. When the selector valve 100 is configured in a second position, such as shown in FIG. 7, the selector valve 100 draws fuel from a secondary fuel tank (not shown) and directs the fuel to the engine. The selector valve 100 also directs any fuel returned from the engine back to the secondary fuel tank.

More specifically described, to operate the selector valve 100 in the above manner, the first port 114 is coupled to the draw line of the primary fuel tank, the second port 116 is coupled to the draw line of the secondary fuel tank, and the third port 118 is coupled the vehicle's fuel system to provide fuel to the vehicle's engine. Likewise, the fourth port 120 is coupled to the return line of the primary fuel tank, the fifth port 122 is coupled to the return line of the secondary fuel tank, and the sixth port 124 is coupled to the vehicle's fuel system to receive return/recycled/excess fuel from the vehicle's fuel system.

Thus, during operation, fuel is drawn through the first port 114, enters the center passage 174, and then enters the first cavity 170, wherein the fuel is impeded from continuing along the center passage 174 by the presence of the first sealing member 154 against the second sealing surface 104. Thus, the fuel is directed upwards in the first cavity 170 and out the third port 118 and to the vehicle's fuel system.

Fuel returned from the vehicle's fuel system is directed down through the sixth port 124 into the second cavity 172. The fuel is impeded from traveling through the center passage 174 to the fifth port 122 by the second sealing member's 156 sealing engagement with the fourth sealing surface 108. Thus, the fuel travels along the center passage 174 to the fourth port 120 and is directed to the primary fuel tank. Thus, it can be seen that in the first position, the selector valve 100 directs fuel between the primary tank and the vehicle's engine. The selector valve 100 is normally biased in this position by the biasing member 162.

When the selector valve 100 is to be configured in the second position, the actuator assembly 126 is energized such that the solenoid 158 drives the actuator shaft 165 to the right from the position shown in FIG. 6 to the position shown in FIG. 7. Turning now to FIG. 7, the selector valve 100 is now in the second position. In the second position, the selector valve 100 directs fuel exchange between the vehicle's secondary fuel tank and the engine's fuel system.

More specifically, with the selector valve 100 in the second position, fuel is drawn through the second port 116, enters the center passage 174 and enters the first cavity 170, wherein the fuel is impeded from continuing along the center passage 174 by the presence of the first sealing member 154 seating against the first sealing surface 102. Thus, the fuel is directed upwards in the first cavity 170 and out the third port 118 and to the vehicle's fuel system.

Fuel returned from the vehicle's fuel system is directed down through the sixth port 124 into the second cavity 172. The fuel is impeded from traveling through the center passage 174 to the fourth port 120 by the second sealing member's 156 sealing engagement with the third sealing surface 106. Thus, the fuel travels along the center passage 174 to the fifth port 122 and is directed to the secondary fuel tank. Thus, it can be seen that in the second position, the selector valve 100 directs fuel between the secondary tank and the vehicle's engine. The selector valve 100 is held in this position against the biasing member 162 as long as the solenoid 158 remains energized.

Due to the modular design of the illustrated selector valve 100, the selector valve 100 may be adapted to accommodate many different environmental situations. For instance, referring to FIG. 8, the orientation of the first, second, and third ports 114, 116, and 118 may be adjusted relative to the orientation of the fourth, fifth, and sixth ports 120, 122, and 124. More specifically, the second modular valve body 112 may be removed and rotated 90 degrees, and refastened to the first modular valve body 110 such that the fourth, fifth, and sixth ports 120, 122, and 124 are now 90 degrees out of phase from the first, second, and third ports 114, 116, and 118. The reorientation of the ports may be required for many reasons, such as to orient the ports away from obstructions or to place the ports in an orientation better able to accommodate piping connected to the ports. Although the illustrated embodiment is illustrated and described as accommodating only 90 degree rotations of three of the ports relative to the remaining three ports, it should be apparent to those skilled in the art that other embodiments which permit rotations of any angular displacements or which permit the rotation of the ports individually or any combination thereof is within the spirit and scope of the present invention. Likewise, the mounting plate 128 and/or the actuator assembly 126 may be removed, rotated in 90 degree increments, and reattached to the first or second modular valve bodies 110 and 112 to accommodate a variety of mounting locations and plumbing needs.

In another example of the adaptability of the selector valve 100, referring to FIG. 9, one of the modular selector valve bodies may be removed from the selector valve 100. For instance, the second modular valve body and the diaphragm may be removed from the previously described configuration and a shortened actuator shaft installed. The mounting plate 128 and end plate 140 are then attached to the first modular valve body 110 as previously described. The first modular valve body 110 operates as described above, and thus is suitable for use in a vehicle wherein the fuel system does not require fuel recirculation, i.e. fuel is delivered on an as needed basis such that all fuel delivered is combusted.

Further, referring now to FIG. 10, due to the modular design of the illustrated selector valve 100, a third modular valve body 113 may be added to the selector valve 100. A lengthened actuator shaft is also added, along with a third sealing member and a second diaphragm. This configuration may be used when multiple flow paths are desired to be controlled by the selector valve 100.

As should be apparent to those skilled in the art, a selector valve formed in accordance with the present invention may have any number of modular valve bodies, including one as shown in FIG. 9, or any other number, including those having two as shown in FIG. 1, three as shown in FIG. 10, or four or more modular valve bodies. Thus, the illustrated embodiment of the selector valve may be adapted to accommodate many different environments.

Although the above described embodiments are described and illustrated for use in combination with a vehicle's fuel system for illustrative purposes, it should be apparent to those skilled in the art that selector valves formed in accordance with the present invention are suitable for any use requiring the selective directing of a fluid between one or more flow paths.

Further, although the above described embodiments are described and illustrated as being modular in design, it should be apparent that non-modular selector valves are also within the spirit and scope of the present invention.

Further still, although the above described embodiments are described and illustrated as utilizing a solenoid to configure the valve between positions, it should be apparent that the solenoid is illustrative in nature, and any means for configuring the selector valve between positions may be utilized and is within the spirit and scope of the present invention, a few suitable examples being mechanical, electro-mechanical, and pressure actuators, such as diaphragm-based actuators.

Additionally, although each modular valve body is illustrated and described as forming a three-way valve, it should be apparent to those skilled in the art that the modular valve bodies may include any number of ports, and thus, any type of valves, such as a two-way valve, a four-way valve, etc.

While the preferred embodiment of the invention has been illustrated and described, it will be appreciated that various changes can be made therein without departing from the spirit and scope of the invention.

1. A modular selector valve for selectively directing fluid flow between two or more flow paths, the modular selector valve comprising:
(a) a valve housing having a first sealing surface and a second sealing surface substantially facing each other, the first and second sealing surfaces integrally formed with the valve housing so as to be non-removably and homogeneously formed with the valve housing;
(b) a cavity disposed in the valve housing between the first and second sealing surfaces;
(c) a first port in fluid communication with the cavity and the first sealing surface;
(d) a second port in fluid communication with the cavity and the second sealing surface;
(e) a third port in fluid communication with the cavity;
(f) a sealing member moveable within the cavity to selectively seal against the first or second sealing surface to selectively impede flow through the first and second ports, and
(g) an actuator assembly having an actuator shaft coupled to the sealing member, the actuator assembly adapted to drive the actuator shaft within the cavity to move the sealing member between the first and second sealing surfaces,
wherein the actuator assembly is removably coupled to the valve housing so that a second valve housing can be operatively coupled therebetween.

2. The modular selector valve of claim 1, wherein the third port is removably attached to the valve housing to permit the sealing member to be inserted into the cavity when the third port is removed from the valve housing.

3. (canceled)

4. The modular selector valve of claim 1, wherein the actuator shaft includes a reduced profile section and the sealing member includes an elastic aperture, wherein the elastic aperture is adapted to expand to permit the sealing member to slip over the actuator shaft and contract when present in the reduced profile section to retain the sealing member in the reduced profile section.

5. The modular selector valve of claim 4, wherein the third port is removably attached to the valve housing to permit the sealing member to be inserted into the cavity, and wherein the actuator shaft is adapted to be inserted through the cavity and slipped through the elastic aperture of the sealing member while the sealing member is in the cavity.

6. The modular selector valve of claim 1, wherein the actuator assembly is adapted to be coupled in two or more angular orientations to the valve housing.

7. The modular selector valve of claim 1, wherein a first side of the sealing member engages the first sealing surface and the second side of the sealing member engages the second sealing surface.

8. The modular selector valve of claim 1, wherein the sealing member is moveable between a first position in which a first side of the sealing member is in sealing engagement with the first sealing surface such that a fluid flow is directed between the third and second ports and not the first port and a second position in which a second side of the sealing member is in sealing engagement with the second sealing surface such that the fluid flow is directed between the third and first ports and not the second port.

9. A modular selector valve assembly for selectively directing flow between two or more flow paths, the modular selector valve assembly comprising:
(a) a first selector valve body comprising:
(i) a first cavity disposed in the first selector valve body;
(i) a first port in fluid communication with the first cavity;
(ii) a second port in fluid communication with the first cavity;
(iii) a third port in fluid communication with the first cavity; and
(b) a second selector valve body removably coupled to the first selector valve body, the second selector valve body comprising:
(i) a second cavity disposed in the second selector valve body;
(i) a fourth port in fluid communication with the second cavity;
(ii) a fifth port in fluid communication with the second cavity;
(iii) a sixth port in fluid communication with the second cavity; and
(c) an actuator having a first sealing member and a second sealing member coupled thereto, wherein the actuator is moveable to position the first and second sealing members to impede flow through either the first and fourth ports or the second and fifth ports.

10. The modular selector valve assembly of claim 9, wherein the actuator is moveable to a first position such that the first sealing member is positioned in the first cavity to direct a fluid flow between the third and first ports and not the second port and the second sealing member is positioned in the second cavity such that the fluid flow is directed between the sixth and fourth ports and not the fifth port and a second position such that the first sealing member is positioned in the first cavity to direct a fluid flow between the third and second ports and not the first port and the second sealing member is positioned in the second cavity such that the fluid flow is directed between the sixth and fifth ports and not the fourth port.

11. The modular selector valve assembly of claim 9, wherein the second selector valve body is adapted to be coupled to the first selector valve body in a plurality of angular orientations such that the orientation of the fourth, fifth, and sixth ports may be adjusted relative to the orientation of the first, second, and third ports by rotating the first and second selector valve bodies relative to one another.

12. The modular selector valve assembly of claim 11, wherein an actuator mechanism for moving the actuator is adapted to be coupled to the first or the second selector valve body in a plurality of angular orientations.

13. A modular selector valve assembly for selectively directing flow between two or more flow paths, the modular selector valve comprising:
(a) a first modular selector valve body selectively couplable to a second modular selector valve body substantially identical to the first modular selector valve body to selectively expand the modular selector valve assembly such that the second modular selector valve body, when attached to the first modular selector valve body, is adapted to be simultaneously actuated by an actuator common to both the first and second modular valve bodies, the first modular valve body comprising:
(i) a first cavity disposed in the first selector valve body;
(ii) a first port in fluid communication with the first cavity;
(iii) a second port in fluid communication with the first cavity;
(iv) a third port in fluid communication with the first cavity; and
(b) an actuator having a first sealing member coupled thereto, wherein the actuator is moveable to a first position such that the first sealing member is positioned in the first cavity to direct a fluid flow between the third and first ports and not the second port and a second position such that the first sealing member is positioned in the first cavity to direct the fluid between the third and second ports and the not the first port.

14. The modular selector valve assembly of claim 13, wherein the first modular valve body is adapted to permit the second modular valve body to be coupled to the first modular valve body in a plurality of angular orientations.

15. The modular selector valve assembly of claim 14, wherein the first modular valve body includes a passageway that passes through the first modular valve body thereby permitting the actuator to extend through the first modular valve body to be received by the second modular valve body when coupled to the first modular valve body.

16. The modular selector valve assembly of claim 15, wherein the passageway is in fluid communication with the first, second, and third ports.

17. The modular selector valve assembly of claim 13, further including a first sealing surface and a second sealing surface substantially facing each other, the first and second sealing surfaces integrally formed with the first modular valve body so as to be non-removable and homogeneously formed with the first modular valve body, the first and second sealing surfaces disposed in the first cavity and adapted to sealingly engage the first sealing member to selectively block flow through the second and first ports.

18. The modular selector valve assembly of claim 13, wherein the third port is removably attached to the first modular valve body such that the third port may be removed to permit insertion of the first sealing member into the first cavity.

19. The modular selector valve assembly of claim 13, wherein the first modular valve body is adapted to receive an end plate for sealing off the first cavity when the first modular valve body is not coupled to the second modular valve body.

20. A modular selector valve for selectively directing fluid flow between two or more flow paths, the modular selector valve comprising:
(a) a valve housing having a first sealing surface and a second sealing surface;
(b) a cavity disposed in the valve housing between the first and second sealing surfaces;
(c) a first port in fluid communication with the cavity and the first sealing surface;
(d) a second port in fluid communication with the cavity and the second sealing surface;
(e) a third port in fluid communication with the cavity, the third port removably coupled to the valve housing; and
(f) a sealing member moveable within the cavity to seal against the first and second sealing surfaces, the sealing member sized and shaped to be inserted into the cavity when the third port is removed from the valve housing; and
(g) an end plate removably coupled to the valve housing so that a second valve housing can be operatively coupled therebetween.

21. The modular selector valve of claim 20, wherein the first and second sealing surfaces are integrally formed with the valve housing so as to be non-removably and homogeneously formed with the valve housing.

22. The modular selector valve of claim 20, wherein the sealing member is moveable between a first position in which a first side of the sealing member is in sealing engagement with the first sealing surface such that a fluid flow is directed between the third and second ports and not the first port and a second position in which a second side of the sealing member is in sealing engagement with the second sealing surface such that the fluid flow is directed between the third and first ports and not the second port.

23. The modular selector valve of claim 20, further including a second valve housing removably coupled to the first valve housing, the second valve housing comprising:
(a) a third sealing surface and a fourth sealing surface;
(b) a second cavity disposed in the second valve housing between the third and fourth sealing surfaces;
(c) a fourth port in fluid communication with the second cavity and the third sealing surface;
(d) a fifth port in fluid communication with the second cavity and the fourth sealing surface;
(e) a sixth port in fluid communication with the second cavity; and
(f) a second sealing member disposed in the second cavity and linked to the sealing member of the first valve housing such that movement of one of the sealing member results in movement of the other sealing member.

24. A selector valve for selectively directing a flow of a fluid, the selector valve comprising:
(a) a first three-way valve;
(b) a second three-way valve coupled to the first three-way valve; and
(c) an actuator assembly for simultaneously actuating the first and second three-way valves to selectively change a flow of a fluid through the first and second three-way valves, wherein the first three-way valve is rotatingly coupled to the second three-way valve such that an orientation of the first three-way valve may be adjusted relative to the second three-way valve.

25. The selector valve of claim 24, wherein the first three-way valve includes a port for permitting a flow of a fluid in or out of the selector valve, the port removably attached to the first three-way valve to permit a sealing member for selectively impeding flow through the first three-way valve to be inserted into the first three-way valve once the port is removed.

26. A modular selector valve for selectively directing a flow of a fluid, the modular selector valve comprising:
(a) two or more three-way valves removably coupled to one another; and
(b) an actuator assembly actuatable to simultaneously actuate each of the two or more three-way valves between a first position in which a fluid is directed along a first path through each of the two or more three-way valves and a second position in which the fluid is directed along a second path through each of the two or more three-way valves.

27. The modular selector valve of claim 26, wherein the two or more three-way valves are each rotatable relative to one another such that an orientation of any one of the two or more three-way valves may be adjusted relative to the other of the two or more three-way valves.

28. The modular selector valve of claim 26, wherein at least one of the two or more three-way valves includes a port for permitting a flow of a fluid in or out of the selector valve, the port removably attached to the three-way valve to permit a sealing member for impeding flow through the three-way valve to be inserted into the three-way valve once the port is removed.
